(19) United States
(12) Patent Application Publication
(10) Pub. No.: US 2005/0151695 A1
(43) Pub. Date: Jul. 14, 2005

(54) Waveguide apparatus and method

(76) Inventors: Ming Chen, Kent, WA (US); Jimmy S. Takeuchi, Mercer Island, WA (US)

Correspondence Address: HARNESS, DICKEY & PIERCE, P.L.C., P.O. BOX 828, BLOOMFIELD HILLS, MI, 48303, US

(21) Appl. No.: 10/757,179

(22) Filed: Jan. 14, 2004

(51) Int. Cl. H01Q 13/00

(52) U.S. Cl. 343/786; 343/785

(57) ABSTRACT

A waveguide transition for use with an antenna aperture. The waveguide includes a tubular waveguide component with a concentrically disposed dielectric insert. In one embodiment the inner surface of the waveguide component is non-linear and formed by either a gradually curving surface or a plurality of linear sections disposed adjacent one another to form an overall non-linear surface when viewed in profile. In other embodiments the outer surface of the dielectric insert is shaped so as to form either a gradually curving surface or by a plurality of non-linear, adjacently formed sections that form an overall non-linear shape when the dielectric insert is viewed in profile. The waveguide of the present invention produces significantly improved cut-off frequency performance that allows a greater degree of flexibility in designing the antenna aperture with a desired operating frequency bandwidth.

### STATEMENT OF GOVERNMENT RIGHTS

This invention was conceived and/or reduced to practice under U.S. Government Contract No. NRO-000-02-C-0032. The U.S. Government has certain rights in this invention.

### FIELD OF THE INVENTION

The present invention relates to electromagnetic wave antennas, and more particularly to a waveguide for use with electromagnetic wave antennas, wherein the waveguide forms a tapering transition region that more effectively channels an electromagnetic wave signal therethrough without cutting off various portions of the frequency band of the signal.

### BACKGROUND OF THE INVENTION

Waveguides, and particularly circular waveguides, are an important part of antenna design. Circular waveguides are used extensively in phased array antennas that are important in low-cost mobile and satellite communications. In such applications, typically an array of circular waveguides are incorporated to form the aperture of the phased array antenna for transmitting or receiving electromagnetic wave signals that are transmitted through free space. The precise diameter of the circular waveguide is determined by the performance requirements of the specific antenna with which the waveguide is being used. In part, such requirements include the frequency and bandwidth of the electromagnet wave signals and the maximum desired scanning angle of the phased array antenna, the desired overall efficiency of the antenna, as well as array packaging design and manufacturing capabilities.

Once the waveguide diameter is selected, it is always necessary to have waveguide transitions for bridging waveguides of different diameters to accommodate the needs of component (e.g., antenna module, filter, etc.) and array testing. It will be appreciated that standard and well known procedures exist for designing a circular waveguide transition section with a tapered, low loss dielectric rod inserted inside the tapered waveguide section. An illustration of the tapered transition section with a loaded dielectric insert is shown in FIG. 1. This conventional waveguide structure includes a tubular waveguide component 10 and a dielectric insert 12 disposed within the waveguide component 10. An inner surface 14 of the waveguide component 10 is linear along substantially its entire length, or it entire length, while an outer surface 16 of the dielectric insert 12 is also linear along its entire length, or substantially along its entire length. The performance of the waveguide transition of FIG. 1 can be predicted using the equations:
a(z, zₜᵢₚ)·in⁻¹
−a(z, zₜᵢₚ)·in⁻¹
b(z)·in⁻¹
b(z)·in⁻¹
−b(z)·in⁻¹
where “a” is the radius of the dielectric insert; and
where “b” is the inside radius of the metal waveguide at any waveguide cross section;
where “z” is the distance in inches of the transition region;
where “ztip” is the diameter of the tip of the dielectric; and
where “in” indicates the unit “inches”

$$\underline{{f}_{c}} ( 1 , b ( z ) , \frac{a ( z , {z}_{tip} )}{b ( z )} , {ɛ}_{Γ} , 1 )$$
where “f_{c}” is the cut-off frequency; and
where “\dot{ε}ᵣ” is the relative dielectric constant of the material comprising the dielectric insert.

When solving the above-described formulas, the cut-off frequency of a plurality of waveguide modes for any combination of diameters of waveguide and dielectric load can be determined. The region formed between the inner surface 14 of the waveguide component 10 and the outer surface 16 of the dielectric insert 12 forms a conventional, tapering transition region that is reduced gradually along the length of the waveguide. A desirable waveguide design would place the waveguide operating frequency band above a cut-off frequency over the whole transition length of the waveguide component. However, with reference to FIG. 2, it can be seen that the calculated mode cut-off frequencies imposed by the waveguide of FIG. 1, being significantly non-linear, can effectively cut-off a portion of an operating frequency band, represented by dashed lines 20, if the operating frequency band is not selected to be above the mode cut-off frequencies of the waveguide. With certain antenna designs, it is not always possible to select the operating frequency such that the mode cut-off frequencies imposed by the waveguide will not cut-off portions of signals within the operating frequency bandwidth. Furthermore, the frequency cut-off problem imposed by the conventional waveguide of FIG. 1 is such that it cannot be remedied simply by adjusting the taper of the inside surface of the waveguide member and/or the taper of the outer surface of the dielectric insert. This limitation significantly constrains the design of phased array antennas.

### SUMMARY OF THE INVENTION

The present invention is directed to a waveguide apparatus and method that provides a reduced, and more linear frequency cut-off profile. This allows antennas, such as phased array antennas, being used with the waveguide to be designed with an operating frequency bandwidth that will not be adversely affected by the cut-off frequency of the waveguide. More specifically, this allows a phased array antenna to be designed with a desired operating bandwidth that is not constrained by the cut-off frequencies imposed by the waveguide with which it is being used.

In one preferred form the present invention comprises a tubular waveguide structure having a tapering internal surface. A dielectric insert is disposed within the tubular waveguide structure. The dielectric insert has an outer surface. The inner surface of the waveguide structure and the outer surface of the dielectric insert cooperatively form an annular, tapering transition region for channeling electromagnetic wave energy between the waveguide structure and an antenna aperture. At least one of the internal surface of the waveguide structure or the outer surface of the dielectric insert is non-linear, and thus forms a non-linear profile. In one preferred embodiment, the dielectric insert includes a gradually curving outer surface that forms a gradually curving, conical shape when viewed in profile. In another preferred embodiment the dielectric insert includes a plurality of distinct, linear sections disposed adjacent one another that form an overall, non-linear shape.

In other preferred embodiments various curvatures of the inner surface of the waveguide member and outer surface of the dielectric member are disclosed along with associated frequency cut-off performance graphs. An embodiment of the waveguide particularly well suited for use in the Ku-band (12 GHz-18 GHz) frequency spectrum is also disclosed.

In still other preferred embodiments, the internal surface of the waveguide member forms a gradually curving surface that is non-linear in profile. Still another alternative preferred embodiment has the inner surface of the waveguide member comprised of a plurality of distinct, linear sections disposed adjacent one another to form an overall non-linear shape when viewed in profile.

Each of the preferred embodiments described above forms essentially an annular, tapering channel when viewed in cross-section. This provides a significantly “flatter” cut-off frequency and eliminates the problem of the waveguide effectively cutting off portions of the electromagnetic wave signal at various frequencies within the operating bandwidth of the antenna aperture with which the present invention is being used.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a simplified side cross-sectional view of a conventional waveguide;

FIG. 2 is a plot of the cut-off frequencies imposed by the waveguide of FIG. 1 relative to an operating bandwidth of an antenna, wherein “fc” is the cutoff frequency, “z” is the distance in inches of the transition region, and the operating bandwidth is represented by dashed lines;

FIG. 3 is a side elevation view of a waveguide in accordance with a preferred embodiment of the present invention;

FIG. 4 is a side cross-sectional view of the waveguide of FIG. 3;

FIG. 5 is a graph of the cut-off frequency performance of the waveguide of FIG. 3;

FIG. 6 is a cross-sectional view of a portion of a waveguide in accordance with an alternative preferred embodiment of the present invention, wherein the dielectric insert incorporates a plurality of distinct linear sections that form an overall, non-linear, conical shape when viewed in profile;

FIG. 7 is a graph of the cut-off frequency performance of the waveguide of FIG. 6;

FIG. 8 illustrates an alternative preferred embodiment of the waveguide of the present invention wherein the inner surface of a tubular waveguide member forms a gradually curving surface, but the dielectric insert includes a linear outer surface;

FIG. 9 is a graph of the cut-off frequency performance of the waveguide of FIG. 8;

FIG. 10 illustrates another alternative preferred embodiment of the present invention wherein the inner surface of the tubular waveguide member includes a plurality of distinct linear sections adjacent one another that form an overall, non-linear shape when viewed in profile, and the dielectric insert includes linear surfaces;

FIG. 11 is a graph of the cut-off frequency performance of the waveguide of FIG. 10.

FIG. 12 illustrates a simplified side cross sectional view of another alternative preferred embodiment of the waveguide in which both the inner surface of the waveguide member and the outer surface of the dielectric insert have gradually curving profiles;

FIG. 13 is a graph of the cut-off frequency performance of the waveguide of FIG. 12;

FIG. 14 illustrate a simplified side cross sectional view of still another alternative preferred embodiment of the waveguide in which both the inner surface of the waveguide member and the outer surface of the dielectric insert have each have a plurality of distinct linear sections that form a non-linear surface;

FIG. 15 is a graph of the cut-off frequency performance of the waveguide of FIG. 14:

FIG. 16 illustrate a simplified side cross sectional view of another alternative preferred embodiment of the waveguide in which both the inner surface of the waveguide member and the outer surface of the dielectric insert have gradually curving, concave tapers;

FIG. 17 is a graph of the cut-off frequency performance of the waveguide of FIG. 16;

FIG. 18 illustrates a simplified side cross sectional view of another alternative preferred embodiment of the waveguide, specifically adapted for use in the Ku-band frequency spectrum (12 GHz-18 GHz); and

FIG. 19 is a graph of the cut-off frequency performance of the waveguide of FIG. 18.

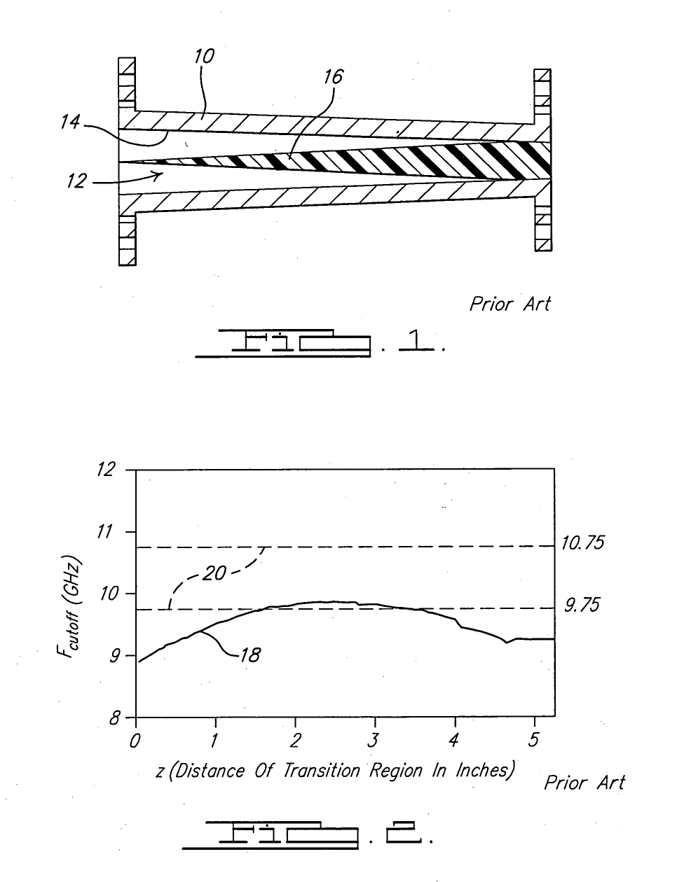

### DETAILED DESCRIPTION OF THE PREFERRED EMBODIMENTS

The following description of the preferred embodiment(s) is merely exemplary in nature and is in no way intended to limit the invention, its application, or uses.

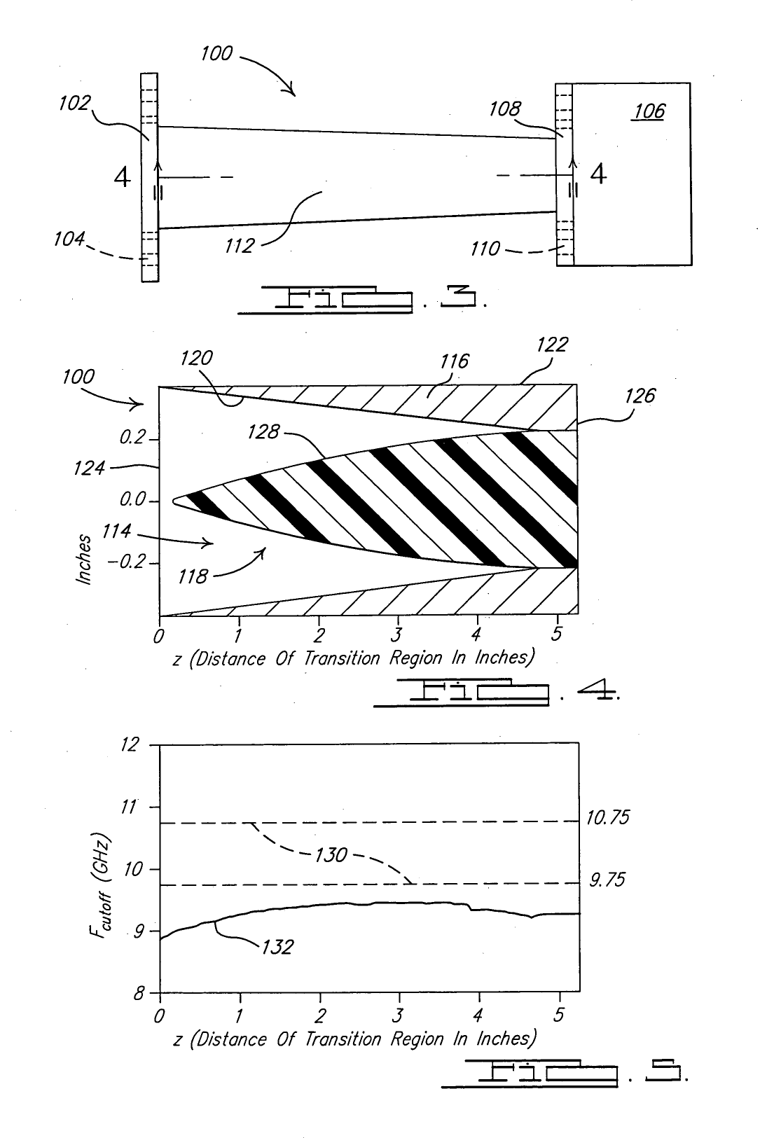

Referring to FIG. 3, there is shown a waveguide 100 in accordance with a preferred embodiment of the present invention. The waveguide 100 includes a first flange portion 102 having a plurality of bores 104 for coupling to an external structure (not shown), such as for test purposes. An antenna aperture 106 is coupled to a second flange 108 via a plurality of spaced apart openings 110. The waveguide 100 includes a tapering transition region 112 that forms a channel 114 for directing electromagnetic wave energy between the aperture 106 and a circuit assembly or other form of external component.

Referring to FIG. 4, a simplified cross-sectional view of a portion of the waveguide 100 is illustrated. The waveguide 100 includes a tubular waveguide component or member 116 within which is inserted a dielectric insert 118. The waveguide component is typically made from an electrical conductor, such as aluminum or another form of metal. The dielectric insert 118 is disposed concentrically within the tubular waveguide component 116. The tubular waveguide component 116 includes an inner surface 120 and an outer surface 122. Inner surface 120 tapers gradually from a first end 124 to a second end 126 of the tubular waveguide component 116. Thus, when viewed in cross-section, as in FIG. 4, the inner surface 120 forms a linearly tapering region.

With further reference to FIG. 4, the dielectric insert 118 is preferably formed by a solid dielectric material, such as plastic, and more preferably from REXOLITE™ dielectric material. The dielectric insert 118 has an overall conical shape formed by an outer surface 128 that includes a slight, gradual, smooth curvature over at least substantially its entire length. This is in contrast to inner surface 120 which forms a linear surface along at least substantially its entire length. The precise curvature may be varied as needed to tune the waveguide 100 performance for specific applications. In practice, it is preferred to manufacture the dielectric insert 118 with a slightly smaller overall length (preferably about 0.25 inch; 6.35 mm) to reduce the possibility of breakage of the tip during assembly of the waveguide 100.

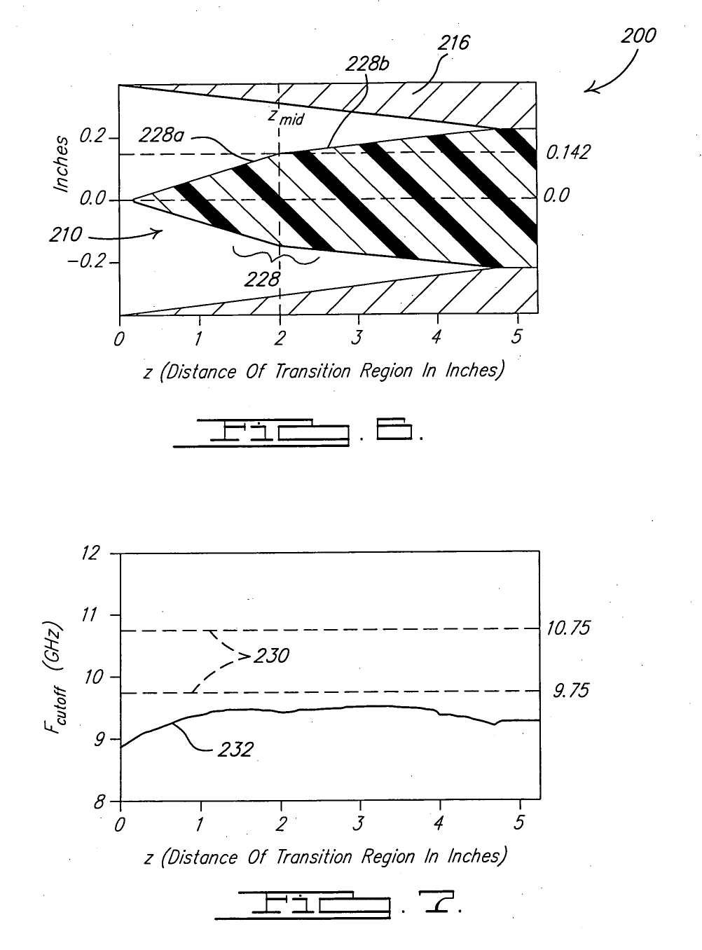

The non-linear (i.e., slightly curving) profile formed by outer surface 128 of dielectric insert 118 provides significant benefits to the performance of the waveguide 100. These are visible in FIG. 5. With brief reference to FIG. 5, dashed lines 130 define an operating frequency bandwidth therebetween. Curve 132 shows the cut-off frequencies produced by the waveguide 100 over the length of its transition region 112. The cut-off frequencies produced by the waveguide 100 at all points along the transition region 112 remain below the operating frequency bandwidth 130. This is in contrast to the cut-off frequencies produced by conventional antenna 10 as shown in FIG. 2, which extend into the operating frequency bandwidth defined in FIG. 2. The “latter” frequency cut-off performance of the waveguide 100 allows the operating frequency bandwidth 130 to be selected closer to the cut-off frequencies of the waveguide than is possible with previously designed waveguides.

Although it will be appreciated that the precise dimensions of the components of the waveguide 100 may vary to tune the waveguide for use with antennas operating at various frequencies, the following Table 1 sets forth various exemplary dimensional values for the components of the wave guide 100:

TABLE 1

| | | | | Transition | Transition | | | |
|---|---|---|---|---|---|---|---|---|
| | Air | Dielectric tip | Transition | mid-section | mid-section | Dielectric | Dielectric | |
| FIG. | guide | recess from air | Length | point length | point | guide | guide | Overall |
| No. | radius | guide end | from tip | from tip | radius | length | radius | length |
| 1 | 0.39 | 0 | 4.75 | n/a | n/a | 0.5 | 0.235 | 5.25 |
| 4 | 0.39 | 0.25 | 4.5 | n/a | n/a | 0.5 | 0.235 | 5.25 |
| 6 | 0.39 | 0.25 | 4.5 | 1.75 | 0.142 | 0.5 | 0.235 | 5.25 |
| 8 | 0.39 | 0.25 | 4.5 | n/a | n/a | 0.5 | 0.235 | 5.25 |
| 10 | 0.39 | 0.25 | 4.5 | 1.75 | 0.363 | 0.5 | 0.235 | 5.25 |
| 12 | 0.39 | 0.25 | 4.5 | n/a | n/a | 0.5 | 0.235 | 5.25 |
| 14 | 0.39 | 0.25 | 4.5 | 1.75 | 0.363/0.135 | 0.5 | 0.235 | 5.25 |
| 16 | 0.39 | 0.25 | 4.5 | n/a | n/a | 0.5 | 0.235 | 5.25 |
| 18 | 0.295 | 0.25 | 3.5 | 1 | 0.07 | 0.5 | 0.165 | 4.25 |

Length
Unit: Inches

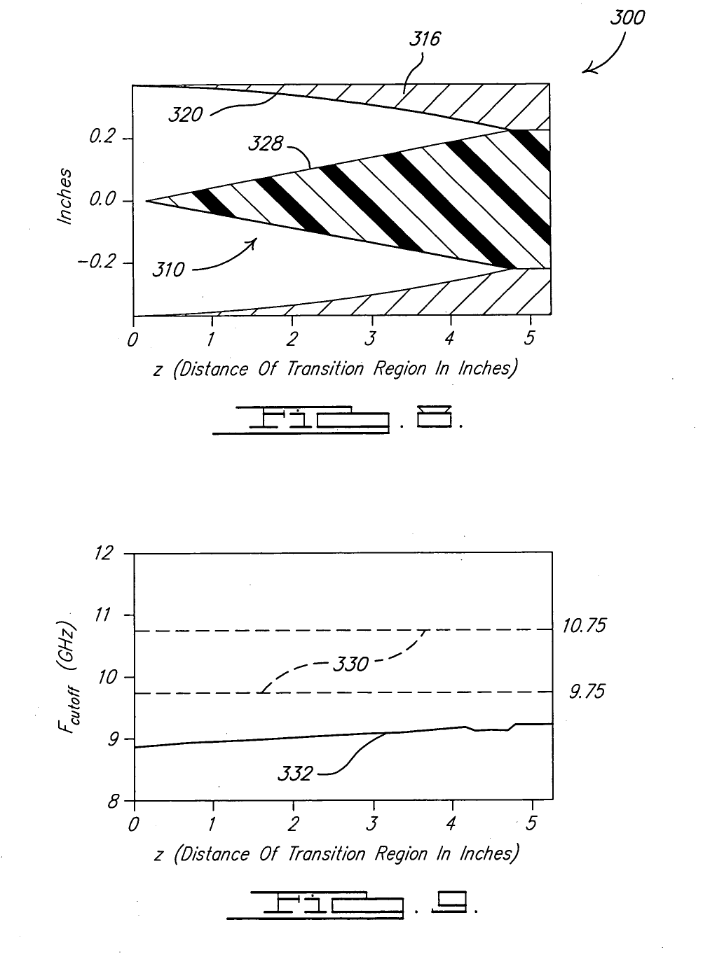

Referring to FIG. 6, a waveguide component 200 in accordance with an alternative preferred embodiment of the present invention is shown. The waveguide component 200 is essentially identical to waveguide component 100, and reference numerals designating components in common with waveguide component 100 are increased by 100 over those used in FIG. 4. The principal difference between waveguide component 200 and waveguide component 100 is in the shape of a dielectric insert 218 thereof. Inner surface 220 is linear over its entire length, or at least substantially its entire length. Dielectric insert 218 includes an outer surface 228 comprised of two distinct linear sections 228a and 228b disposed adjacent one another to form a continuous outer surface that is non-linear and conical when viewed in profile. The length of each section 228a and 228b may be varied to tune the performance of the waveguide as needed. With brief reference to FIG. 7, the dielectric insert 218, in combination with linear inner surface 220, produces a cut-off frequency profile 232 that is significantly flatter than the cut-off frequency curve 18 of FIG. 2, which allows an operating frequency bandwidth 230 to be selected that is lower in frequency without being affected by the cut-off frequencies imposed by the waveguide component 200 over its transition region 216.

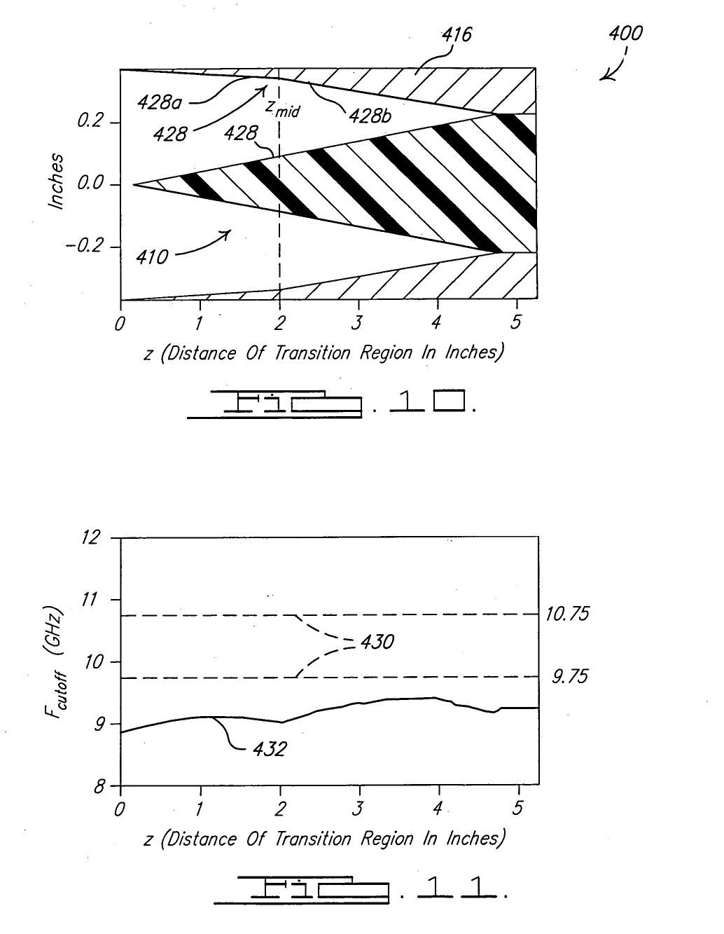

Referring to FIG. 8, a waveguide component 300 in accordance with another alternative preferred embodiment of the present invention is illustrated. Waveguide component 300 is similar to waveguide 100 and common portions are denoted in FIG. 8 by reference numerals increased by a factor of 200 over those used in FIG. 4 to represent waveguide 100. The waveguide component 300 of FIG. 8 includes an inner surface 320 on transition region 312 which curves gradually over substantially its entire length, or over its entire length, in contrast to the linear inner surfaces 120 and 220 described herein. The waveguide component 300 includes a conical dielectric insert 310, however, that has an outer surface 328 that is linear over substantially its entire length, or its entire length. The curving inner surface 320 of the tubular waveguide member 316, in combination with the linear outer surface 328 of the dielectric insert 310, produces a frequency cut-off profile 332 shown in FIG. 9 which is also substantially flatter than that illustrated in FIG. 2. This allows an operating frequency bandwidth 330 to be selected that is lower in frequency.

Referring now to FIG. 10, still another waveguide component 400 in accordance with alternative preferred embodiment of the present invention is shown. Waveguide component 400 is similar to waveguide 100 and like components and portions are designated by reference numerals increased by a factor of 300 over those used with the waveguide 100 shown in FIG. 4. The waveguide component 400 differs from the component 100 by the use of a tubular waveguide component 416 having an inner surface 420 comprised of a plurality of distinct, linear sections 428a, 428b formed adjacent one another to form a continuous non-linear, tapering shape when viewed in cross-sectional profile. A dielectric insert 410 includes an outer surface 428 that forms a smooth, linear surface that appears conical in cross-section.

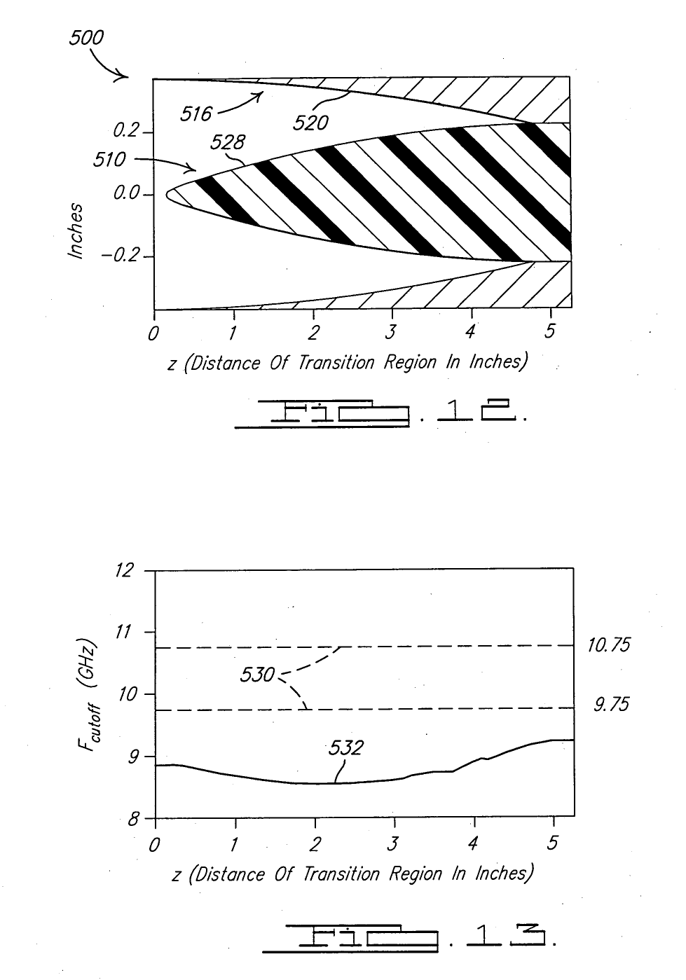

With brief reference to FIG. 11, the cut-off frequency performance of the waveguide component 400 is shown. Cut-off frequency curve 432 can also be seen to be significantly flatter than the cut-off frequency curve 18 of FIG. 2. This allows an operating frequency bandwidth 430 to be selected that is lower in frequency without being adversely effected by the cut-off frequency characteristics of the waveguide component 400.

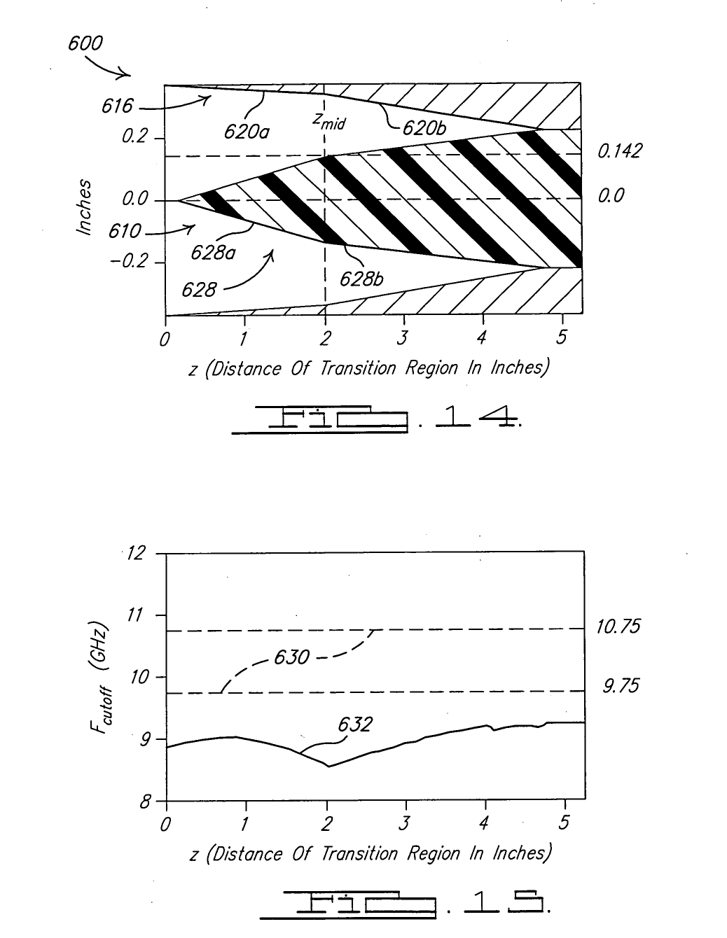

FIG. 12 illustrates a waveguide component 500 in accordance with an alternative preferred embodiment of the present invention. Waveguide component 500 differs from waveguide 100 by the use of a gradually tapering, concave inner surface 520 for the tubular waveguide component 516, and a dielectric insert 510 having a gradually curving outer profile 528. The cut-off frequency performance of the waveguide component is shown in FIG. 13. Cut-off frequency curve 532 is below an operating frequency bandwidth 530.

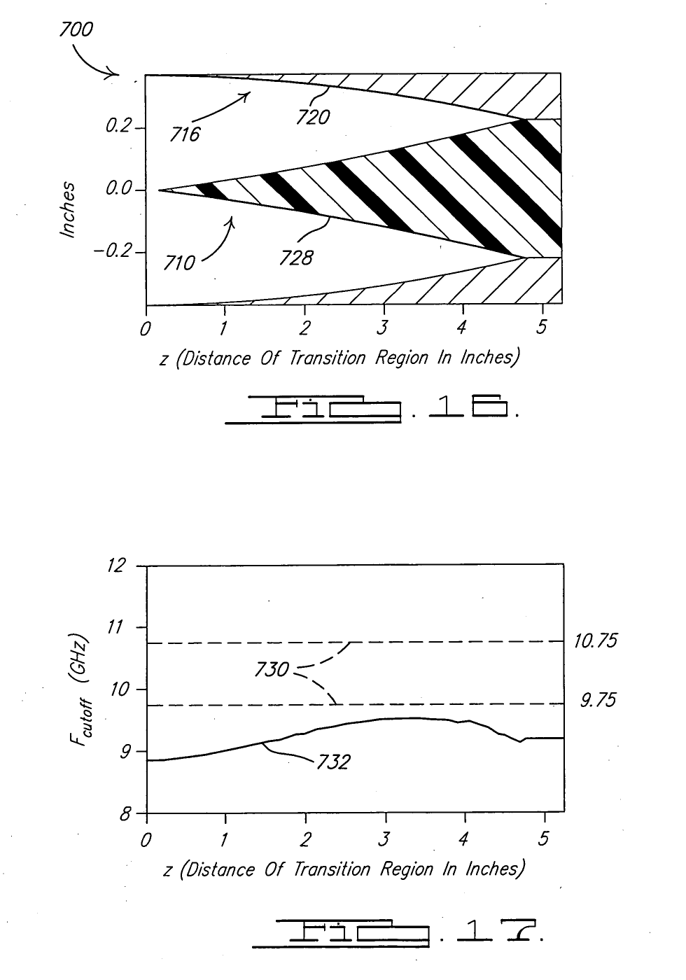

FIG. 14 illustrates a waveguide component 600 in accordance with another alternative preferred embodiment of the present invention. Waveguide component 600 differs from waveguide 100 by the use of an inner surface 620 for the tubular waveguide component 616 having a plurality of distinct linear sections 620a and 620b that form an overall non-linear surface, and a dielectric insert 610 having an outer surface 628 made up of a plurality of distinct linear sections 628a and 628b that make up an overall non-linear surface. FIG. 15 illustrates the cut-off frequency performance of the waveguide component 600. Cut-off frequency curve 632 is maintained below an operating frequency bandwidth 630.

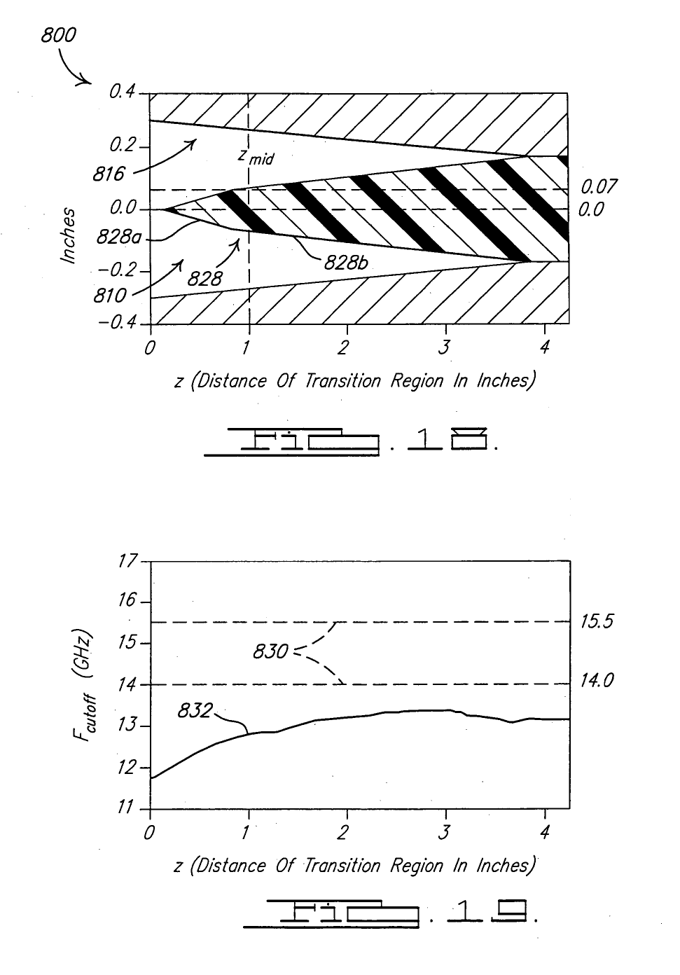

FIG. 16 illustrates still another waveguide component 700 in accordance with an alternative preferred embodiment of the present invention. Waveguide component 700 includes a tubular waveguide component 716 having an inner surface 720 that has a gradually concave taper. Dielectric insert 710 similarly includes a gradual concave taper on its outer surface 728. FIG. 17 illustrates the frequency cut-off performance of the waveguide component 700. Cut-off frequency curve 732 is maintained well below an operating frequency bandwidth 730.

FIG. 18 illustrates another alternative preferred embodiment 800 of the waveguide component of the present invention that is particularly adapted for use in the Ku-band frequency spectrum (12 GHz-18 GHz). The embodiments of FIGS. 4-17, in view of their dimensions, are especially well suited for use in the X-band frequency spectrum (approximately 8 GHz-12 GHz). However, it will be appreciated that further modifications of the length and diameters of the tubular waveguide component 816 and the dielectric insert 810 can be made to tailor the waveguide component for use within other frequency spectra.

The waveguide component 800 is similar to the waveguide component of FIG. 6, with only a slightly shorter overall length of its tubular waveguide component 816 and its dielectric insert 810. An outer surface 828 has linear sections 828a and 828b that form a non-linear surface. FIG. 19 illustrates a frequency cut-off performance curve 832 that is clearly below an operating frequency bandwidth 830, where the bandwidth 830 falls within the Ku-band. It will be appreciated that each of the shapes for the tubular waveguide component and the dielectric insert described relative to FIGS. 4-17 can be applied to the waveguide component 800 to allow even further specific tuning of the performance of the waveguide component 800.

Each of the above described embodiments may be employed in connection with the phased array antenna described in U.S. Pat. No. 6,424,314 to Navarro et al; and/or one or more of the following phased array antennas described in co-pending U.S. patent applications (by Ser. No.) 10/625,767, filed Jul. 23, 2003; Ser. No. 10/200,088, filed Jul. 19, 2002; Ser. No. 10/032,352, filed Dec. 21, 2001 and Ser. No. 09/915,836, filed Jul. 26, 2001, the disclosure of each of which is incorporated by reference into the present application.

The present invention thus forms a waveguide having significantly improved cut-off frequency performance. The cut-off frequency performance of the waveguide allows an operating frequency of an antenna aperture to be selected without the limitations imposed by previously developed waveguides having cut-off frequency performance that limits the selection of the operating frequency bandwidth. The present invention further does not significantly complicate the construction of the waveguide nor increase its overall dimensions or impose significant additional cost in its manufacture or resulting additional weight thereof.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A waveguide for use with an antenna aperture for forming a transition region for channeling electromagnetic wave signals, the waveguide comprising:
a tubular waveguide component having a tapering inner surface;
a dielectric member having a predetermined length and a generally conical profile, and inserted at least substantially into the tubular waveguide component to be at least substantially housed therein; and
wherein at least one of said dielectric member and said tapering inner surface comprises a surface that is non-linear.

2. The waveguide for claim 1, wherein the dielectric member is comprised of a plurality of linear sections forming said generally conical profile;

3. The waveguide of claim 1, wherein the tapering inner surface comprises a plurality of adjacently formed linear surface sections.

4. The waveguide of claim 1, wherein the generally conical profile of said dielectric member comprises a gradually curving surface.

5. The waveguide of claim 1, wherein the tapering inner surface of the tubular waveguide component comprises a gradually curving inner surface.

6. The waveguide of claim 1, wherein the dielectric member is disposed concentrically within said tubular waveguide component.

7. The waveguide of claim 1, wherein said dielectric member has a non-linear outer surface and said tubular waveguide component has a non-linear inner surface.

8. The waveguide of claim 1, wherein said tubular waveguide component and said dielectric member are formed having dimensions in accordance with Table 1 herein.

9. A waveguide comprising:
a tubular waveguide member having a tapering inner wall, said tapering inner wall forming a generally linear surface;
a generally conically shaped dielectric member disposed within said tubular waveguide;
wherein said generally conically shaped dielectric member includes an outer surface that is non-linear over a length thereof.

10. The waveguide of claim 9, wherein said outer surface of said dielectric member comprises a plurality of distinct linear sections formed adjacent one another to form said non-linear outer surface.

11. The waveguide of claim 9, wherein said outer surface of said dielectric member comprises a smoothly curving outer surface.

12. A waveguide comprising:
a tubular waveguide member having a tapering inner wall, said tapering inner wall forming a non-linear surface;
a generally conically shaped dielectric member disposed within said tubular waveguide;
wherein said generally conically shaped dielectric member includes an outer surface that is linear over a length thereof.

13. The waveguide of claim 12, wherein said tapering inner wall of said tubular waveguide member comprises a plurality of distinct linear sections forming said non-linear shape.

14. The waveguide of claim 12, wherein tapering inner wall of said tubular waveguide member comprises a smoothly curving surface.

15. The waveguide of claim 12, wherein said dielectric member is disposed concentrically within said tubular waveguide member.

16. An antenna comprising:
an aperture;
a waveguide in electromagnetic wave communication with said aperture;
said waveguide including:
a tubular member having a tapering inner wall surface;
a dielectric insert having an outer surface, and disposed at least substantially within said tubular member; and
wherein at least one of said tapering inner wall surface and said outer surface of said dielectric insert has a non-linear shape over a length thereof.

17. The antenna of claim 16, wherein said tapering inner wall surface of said tubular member comprises a smoothly curving shape.

18. The antenna of claim 17, wherein said outer surface of said dielectric insert comprises a linear surface.

19. The antenna of claim 17, wherein said tapering inner wall surface of said tubular member comprises a plurality of distinct linear sections forming an overall non-linear profile.

20. The antenna of claim 16, wherein said outer surface of said dielectric insert comprises a smoothly curving shape.

21. The antenna of claim 20, wherein said tapering inner wall surface of said tubular member comprises a linear surface.

22. The antenna of claim 16, wherein said outer surface of said dielectric insert comprises a plurality of distinct linear sections to form an overall non-linear, conical shape.

23. The antenna of claim 22, wherein said tapering inner wall surface of said tubular member comprises a linear surface.

24. The antenna of claim 16, wherein said dielectric member has a non-linear outer surface and said inner surface of said tubular waveguide component is non-linear.

25. A method of channeling electromagnetic wave energy comprising:
forming a waveguide by disposing a dielectric insert within a tubular waveguide member; and
forming one of an outer surface of said dielectric insert, and an inner surface of said tubular waveguide member with a non-linear shape.

26. The method of claim 25, further comprising disposing said dielectric insert concentrically within said tubular waveguide member.

27. The method of claim 25, further comprising forming one of said outer surface of said dielectric insert and said inner surface of said tubular waveguide with a gradually curving, conical shape.

28. The method of claim 25, further comprising forming one of said outer surface of said dielectric insert and said inner surface of said tubular waveguide with a plurality of distinct linear sections disposed adjacent one another to form an overall, non-linear surface.

29. A method of channeling electromagnetic wave energy comprising:
forming an annular waveguide channel from a pair of spaced apart surfaces having a cross sectional area that decreases from a first end of said channel to a second end of said channel; and
further forming a first one of said spaced apart surfaces with a non-linear profile and a second one of said spaced apart surfaces with a linear profile.

30. The method of claim 29, further comprising forming said first one of said spaced apart surfaces as a smoothly, gradually curving surface.

31. The method of claim 29, further comprising forming said first one of said spaced apart surfaces with a plurality of distinct linear sections disposed adjacent one another to thus form said non-linear profile.

32. The method of claim 29, further comprising forming said spaced apart surfaces such that one is disposed concentrically relative to the other.

33. The method of claim 29, further forming one of said spaced apart surfaces out of a dielectric material.

34. The method of claim 29, further comprising forming one of said spaced apart surfaces as a conical surface from a dielectric material.

35. The method of claim 29, further comprising forming one of said spaced apart surfaces as a conical surface from a metal.

36. A phased array antenna comprising:
a plurality of apertures; and
a plurality of waveguides in electromagnetic wave communication with said apertures;
wherein each of said waveguides includes:
a tubular member having an tapering inner wall surface; and
a dielectric insert having an outer surface disposed at least substantially within said tubular member; and
wherein at least one of said tapering inner wall surface and said outer surface of said dielectric insert has a non-linear shape over a length thereof.

37. The phased array antenna of claim 36, wherein dimensions of said tubular member and said dielectric member are defined in accordance with Table 1 herein.

38. A waveguide for an antenna system, comprising:
means for defining a cut-off frequency threshold of the waveguide by controlling a geometry of a tubular waveguide component relative to a dielectric insert disposed within the tubular waveguide component.
